(19) United States
(12) Patent Application Publication
(10) Pub. No.: US 2018/0126805 A1
(43) Pub. Date: May 10, 2018

(54) VALVE STEM SYSTEM

(71) Applicants: Nigel Ramsubagh, Montgomery, TX (US); Carmen Ramsubagh, Montgomery, TX (US)

(72) Inventors: Nigel Ramsubagh, Montgomery, TX (US); Carmen Ramsubagh, Montgomery, TX (US)

(21) Appl. No.: 15/346,272

(22) Filed: Nov. 8, 2016

(51) Int. Cl. B60C 23/04; B60C 29/00

(52) U.S. Cl. CPC B60C 23/0494; B60C 29/005

(57) ABSTRACT

A valve stem system includes a valve stem that is fluidly coupled to a tire thereby facilitating the valve stem to selectively inflate and deflate the tire. A sensing unit is coupled to the valve stem and the sensing unit is visible on the valve stem. The sensing unit is in fluid communication with the valve stem to sense air pressure within the tire thereby facilitating the sensing unit to display the air pressure within the tire.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to valve stem devices and more particularly pertains to a new valve stem device for displaying air pressure in a tire.

### BRIEF SUMMARY OF THE INVENTION

An embodiment of the disclosure meets the needs presented above by generally comprising a valve stem that is fluidly coupled to a tire thereby facilitating the valve stem to selectively inflate and deflate the tire. A sensing unit is coupled to the valve stem and the sensing unit is visible on the valve stem. The sensing unit is in fluid communication with the valve stem to sense air pressure within the tire thereby facilitating the sensing unit to display the air pressure within the tire.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a valve stem system according to an embodiment of the disclosure.

FIG. 2 is a perspective view of an alternative embodiment of the disclosure.

FIG. 3 is a cross sectional view taken along line 3-3 of FIG. 2 of an embodiment of the disclosure.

FIG. 4 is a detail view of an alternative embodiment of the disclosure.

### DETAILED DESCRIPTION OF THE INVENTION

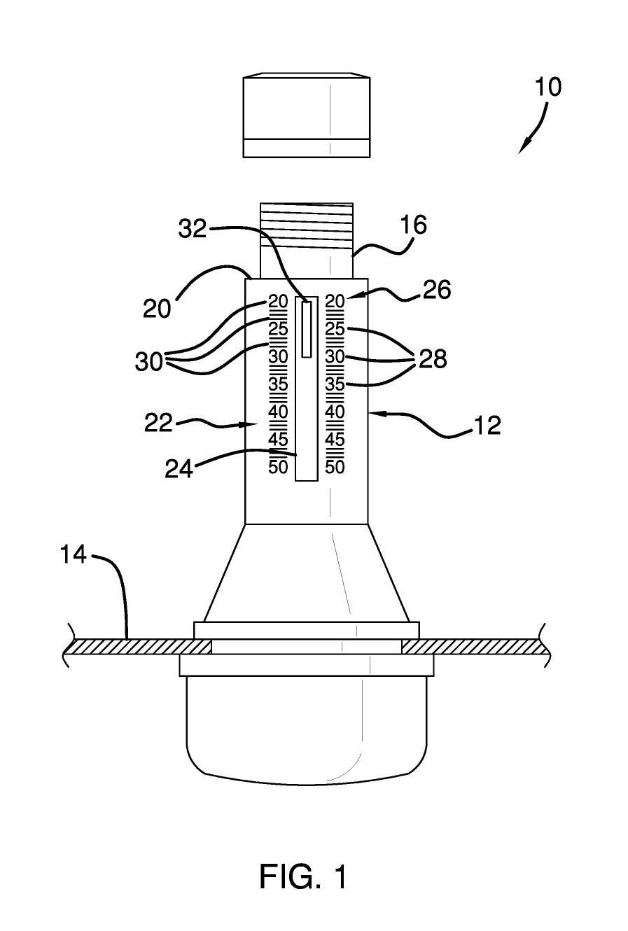

With reference now to the drawings, and in particular to FIGS. 1 through 4 thereof, a new valve stem device embodying the principles and concepts of an embodiment of the disclosure and generally designated by the reference numeral 10 will be described.

As best illustrated in FIGS. 1 through 4, the valve stem system 10 generally comprises a valve stem 12 that is fluidly coupled to a tire 14 thereby facilitating the valve stem 12 to selectively inflate and deflate the tire 14. The tire 14 may be an inflatable tire that is positioned on a vehicle or the like. The vehicle may be a truck, a car, a motorcycle, a trailer or any other vehicle that has inflatable tires. The valve stem 12 may be a tire valve stem 12 of any conventional design.

The valve stem 12 has an outer wall 16 and a chamber 18. The chamber 18 extends longitudinally through the valve stem 12 and the chamber 18 is in fluid communication with an interior of the tire 14. The valve stem 12 is comprised of a fluid impermeable material such as steel or the like. A sleeve 20 is provided and the sleeve 20 is positioned around the valve stem 12. The sleeve 20 is comprised of a fluid impermeable material such as rubber or the like.

A sensing unit 22 is provided and the sensing unit 22 is coupled to the valve stem 12. The sensing unit 22 is positioned to be visible on the valve stem 12. The sensing unit 22 is in fluid communication with the valve stem 12 to sense air pressure within the tire 14. Thus, the sensing unit 22 may display the air pressure within the tire 14.

A gauge 24 is provided and the gauge 24 is coupled to the sleeve 20. Thus, the gauge 24 is visible to an individual. The gauge 24 includes indicia 26 that are printed on an outer surface of the sleeve 20. The indicia 26 comprise graduated pressure numbers 28 and hash marks 30 that are aligned with the graduate pressure numbers. The gauge 24 may be an air pressure gauge 24 or the like.

The gauge 24 includes an indicator 32 that is movably aligned with the indicia 26. The pressure sensor urges the indicator 32 to align with selected ones of the graduated pressure numbers 28 corresponding with air pressure in the tire 14. In this way the indicator 32 indicates the air pressure in the tire 14. The indicator 32 may be comprised of a luminescent material such that the indicator 32 glows in the dark thereby facilitating the indicator 32 to be visible at night. Moreover, the indicator 32 may be an analog pressure gauge 24 or the like.

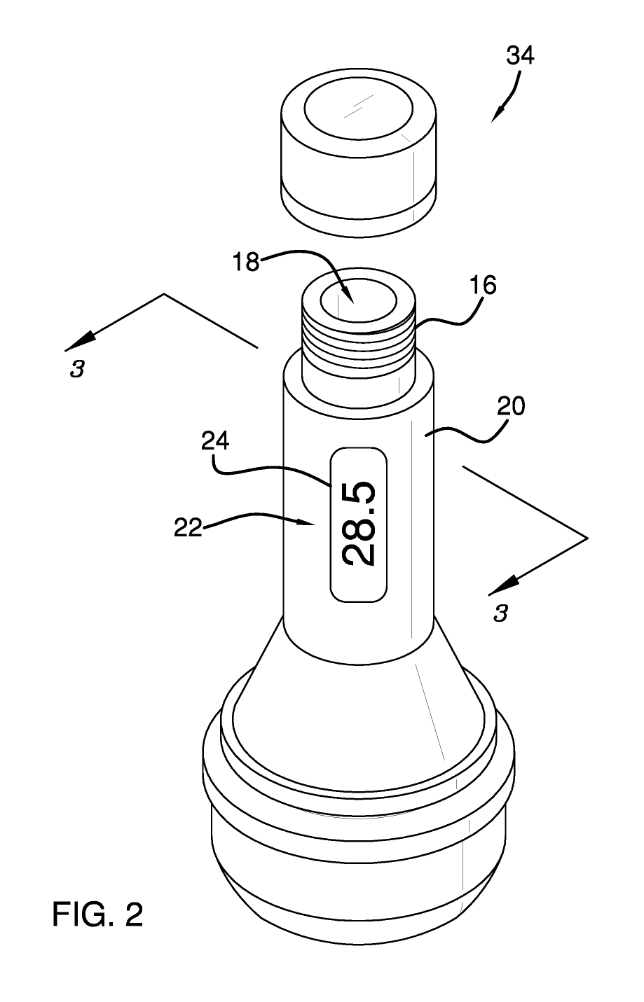

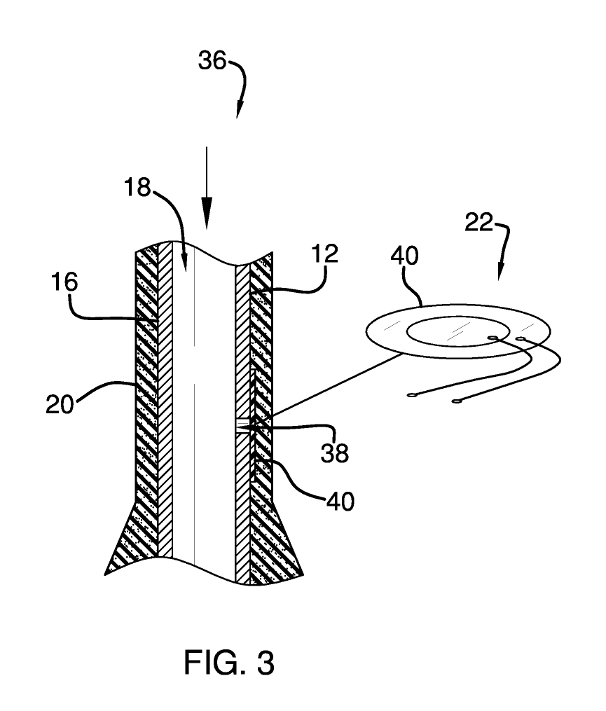

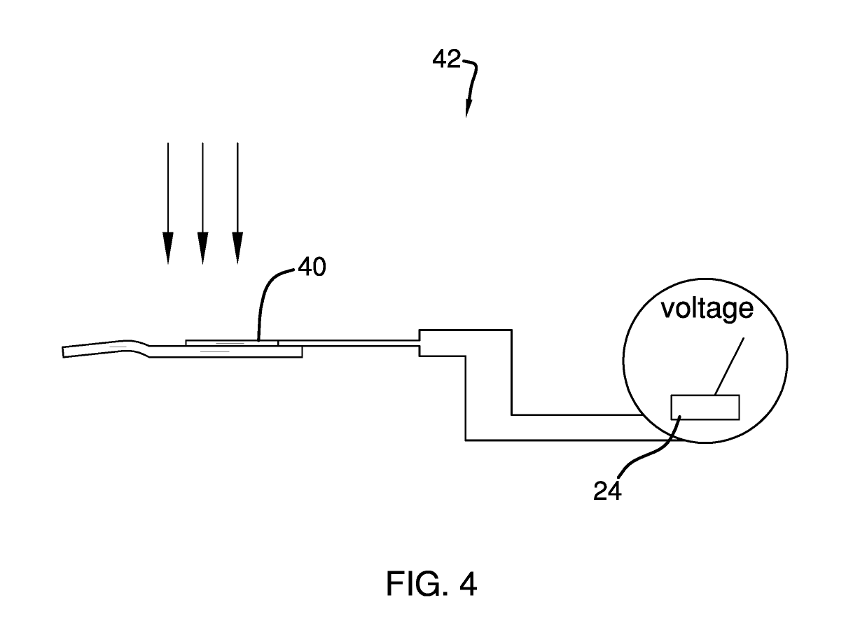

In an alternative embodiment 34 as shown in FIG. 2, the gauge 24 may be a digital gauge or the like. In an alternative embodiment 36 as shown in FIG. 3, the outer wall 16 of the valve stem 12 may have an aperture 38 extending into the chamber 18. The sensing unit 22 may include a pressure sensor 40 that is coupled to the outer wall 16 of the valve stem 12. The pressure sensor 40 may be positioned over the aperture 38 to detect air pressure in the tire 14. Moreover, the pressure sensor 40 may be positioned between the valve stem 12 and the sleeve 20. The pressure sensor 40 may comprise a piezoelectric pressure transducer or the like. In an alternative embodiment 42 as shown in FIG. 4, the pressure sensor 40 may be electrically coupled to the gauge 24.

In use, the valve stem 12 is manipulated in the convention of valve stem 12s with respect to inflating and deflating the tire 14. The gauge 24 displays the air pressure in the tire 14 thereby facilitating the air pressure in the tire 14 to be continually monitored. Moreover, the air pressure in the tire 14 is monitored without the use of an extrinsic air pressure gauge 24.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A valve stem system for displaying air pressure within a tire, said system comprising:
a valve stem being configured to be fluidly coupled to a tire thereby facilitating said valve stem to selectively inflate and deflate the tire; and
a sensing unit being coupled to said valve stem wherein said sensing unit is configured to be visible on said valve stem, said sensing unit being in fluid communication with said valve stem wherein said sensing unit is configured to sense air pressure within the tire thereby facilitating said sensing unit to display the air pressure within the tire.

2. The system according to claim 1, wherein said valve stem has an outer wall and a chamber, said chamber being configured to be in fluid communication with an interior of the tire.

3. The system according to claim 1, wherein said sensing unit includes a gauge being coupled to said valve stem wherein said gauge is configured to be visible.

4. The system according to claim 3, wherein said gauge includes indicia being printed on an outer surface of said sleeve, said indicia comprising graduated pressure numbers, said gauge including an indicator being movably aligned with said indicia, said indicator being aligned with selected ones of said graduated pressure numbers corresponding with air pressure in the tire wherein said indicator is configured to indicate the air pressure in the tire.

5. A valve stem system for displaying air pressure within a tire, said system comprising:
a valve stem being configured to be fluidly coupled to a tire thereby facilitating said valve stem to selectively inflate and deflate the tire, said valve stem having an outer wall and a chamber, said chamber being configured to be in fluid communication with an interior of the tire; and
a sensing unit being coupled to said valve stem wherein said sensing unit is configured to be visible on said valve stem, said sensing unit being in fluid communication with said valve stem wherein said sensing unit is configured to sense air pressure within the tire thereby facilitating said sensing unit to display the air pressure within the tire, said sensing unit comprising a gauge being coupled to said sleeve wherein said gauge is configured to be visible, said gauge being electrically coupled to said pressure sensor, said gauge including indicia being printed on an outer surface of said sleeve, said indicia comprising graduated pressure numbers, said gauge including an indicator being movably aligned with said indicia, said pressure sensor urging said indicator to align with selected ones of said graduated pressure numbers corresponding with air pressure in the tire wherein said indicator is configured to indicate the air pressure in the tire.
